(19) United States
(12) Patent Application Publication
(10) Pub. No.: US 2009/0030552 A1
(43) Pub. Date: Jan. 29, 2009

(54) Robotics visual and auditory system

(75) Inventors: Kazuhiro Nakadai, Chiba (JP); Hiroshi Okuno, Tokyo (JP); Hiroaki Kitano, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAPAN SCIENCE AND TECHNOLOGY AGENCY, SAITAMA (JP)

(21) Appl. No.: 10/539,047

(22) PCT Filed: Feb. 12, 2003
(86) PCT No.: PCT/JP03/01434

§ 371 Date: Apr. 2, 2007

(30) Foreign Application Priority Data
Dec. 17, 2002 (JP) 2002-365764

(51) Int. Cl. G10L 21/02; G10L 15/20; G06F 19/00; G05B 19/00

(52) U.S. Cl. 700/258; 700/245; 700/259; 901/46; 704/275

(57) ABSTRACT

It is a robotics visual and auditory system provided with an auditory module (20), a face module (30), a stereo module (37), a motor control module (40), and an association module (50) to control these respective modules. The auditory module (20) collects sub-bands having interaural phase difference (IPD) or interaural intensity difference (IID) within a predetermined range by an active direction pass filter (23a) having a pass range which, according to auditory characteristics, becomes minimum in the frontal direction, and larger as the angle becomes wider to the left and right, based on an accurate sound source directional information from the association module (50), and conducts sound source separation by restructuring a wave shape of a sound source, conducts speech recognition of separated sound signals from respective sound sources using a plurality of acoustic models (27d), integrates speech recognition results from each acoustic model by a selector, and judges the most reliable speech recognition result among the speech recognition results.

### TECHNICAL FIELD

The present invention relates to a visual and auditory system specifically applicable to humanoid or animaloid robots.

### BACKGROUND ART

Recently such humanoid or animaloid robots are not only the object of AI studies but also considered as so-called “a human's partner” for the future use. In order for a robot to perform intelligently social interactions with human beings, such senses as audition and vision are required to the robots. In order for a robot to realize social interactions with human beings, it is obvious that audition and vision, especially audition, are important function among various senses. Therefore, with respect to audition and vision, a so-called active sense has come to draw attention.

Here, an active sense is defined as the function to keep the sensing apparatus in charge of such senses as robot vision and robot audition to track the target. The active sense, for example, posture-controls the head part supporting these sensing apparatuses so it tracks the target by drive mechanism. In the active vision of a robot, at least the optical axis direction of a camera as a sensing apparatus is held toward the target by posture control by drive mechanism, and further automatic focusing and zoom in and out are performed toward the target. Thereby, even if the target moves, the camera takes its image. Such various studies of active vision have so far been conducted.

On the other hand, in the active audition of a robot, at least the directivity of a microphone as a sensing apparatus is held toward the target by posture control by drive mechanism, and the sounds from the target are collected with the microphone. As a demerit of active audition in this case, since the microphone picks up operational sounds of the drive mechanism in operation, relatively big noise is mixed in the sound from the target, and therefore the sound from the target can not be recognized. In order to eliminate such demerit of active audition, by directing to the sound source, for example, referring to visual information, the method to accurately recognize the sound from the target is adopted.

Here, in such active audition, (A) sound source localization, (B) separation of the sounds from respective sound sources, and (C) sound recognition from respective sound sources are required based on the sounds collected by a microphone. Among them, with regard to (A) sound source localization and (B) sound source separation, various studies are conducted about sound source localization, tracking, and separation in real time and real environments for active audition. For example, as disclosed in a pamphlet of International Publication WO 01/95314, it is known to localize sound source utilizing interaural phase difference (IPD) and interaural intensity difference (IID) calculated from HRTF (Head Related Transfer function). Also in the above-mentioned reference, the method to separate sounds from respective sources by using, for example, a so-called direction pass filter, and by selecting the sub-band having the same IPD as that of a specific direction.

On the other hand, with regard to the recognition of sounds from respective sources separated by sound source separation, various approaches to robust speech recognition against noises, for example, multiconditioning, missing data, or others have been studied.
J. Baker, M. Cooke, and P. Green, Robust as based on clean speechmodels: An evaluation of missing data techniques for connected digit recognition in noise. “7th European conference on Speech Communication Technology”, 2001, Vol. 1, p. 213-216.
Philippe Renevey, Rolf Vetter, and Jens Kraus, Robust speech recognition using missing feature theory and vector quantization. “7th European conference on Speech Communication Technology”, 2001, Vol. 12, p. 1107-1110.

However, in such studies published in the above-mentioned two references, when S/N ratio is small, effective speech recognition can not be conducted. Also, studies in real time and real environments have not been conducted.

### DISCLOSURE OF THE INVENTION

It is the objective of the present invention, taking into consideration the above-mentioned problems, to provide a robotics visual and auditory system capable of recognition of sounds separated from respective sound sources. In order to achieve the above-mentioned objective, a first aspect of the robotics visual and auditory system of the present invention is characterized in that it is provided with a plurality of acoustic models consisting of the words and their directions which each speaker spoke, a speech recognition engine performing speech recognition process to the sound signals separated from respective sound sources, and the selector to integrate a plurality of the speech recognition process results obtained in accordance with acoustic models by said speech recognition process, and to select any one of the speech recognition process results, thereby recognizes the words spoken by respective speakers simultaneously. Said selector may be so constituted as to select said speech recognition process results by majority rule, and provided with a dialogue part to output the speech recognition process results selected by said selector.

According to said first aspect, by using a plurality of acoustic models based on the sound signals conducted sound source localization and sound source separation, the speech recognition processes are performed, respectively, and, by integrating by the selector the speech recognition process results, the most reliable speech recognition result is judged.

In order also to achieve the above-mentioned objective, a second aspect of the robotics visual and auditory system of the present invention is provided with an auditory module which is provided at least with a pair of microphones to collect external sounds, and, based on sound signals from the microphones, determines a direction of at least one speaker by sound source separation and localization by grouping based on pitch extraction and harmonic sounds, a face module which is provided a camera to take images of a robot's front, identifies each speaker, and extracts his face event from each speaker's face recognition and localization, based on images taken by the camera, a motor control module which is provided with a drive motor to rotate the robot in the horizontal direction, and extracts motor event, based on a rotational position of the drive motor, an association module which determines each speaker's direction, based on directional information of sound source localization of the auditory event and face localization of the face event, from said auditory, face, and motor events, generates an auditory stream and a face stream by connecting said events in the temporal direction using a Kalman filter for determinations, and further generates an association stream associating these streams, and an attention control module which conducts an attention control based on said streams, and drive-controls the motor based on an action planning results accompanying the attention control, wherein the auditory module collects sub-bands having interaural phase difference (IPD) or interaural intensity difference (IID) within a predetermined range by an active direction pass filter having a pass range which, according to auditory characteristics, becomes minimum in the frontal direction, and larger as the angle becomes wider to the left and right, based on an accurate sound source directional information from the association module, and conducts sound source separation by restructuring a wave shape of a sound source, conducts speech recognition of the sound signals separated from sound source separation using a plurality of acoustic models, integrates speech recognition results from each acoustic model by a selector, and judges the most reliable speech recognition result among the speech recognition results.

According to such second aspect, the auditory module conducts pitch extraction utilizing harmonic sound from the sound from the outside target collected by the microphone, thereby obtains the direction of each sound source, identifies individual speakers, and extracts said auditory event. The face module extracts individual speakers' face events by face recognition and localization of each speaker by pattern recognition from the images photographed by the camera. Further, the motor control module extracts motor event by detecting the robot's direction based on the rotating position of the drive motor which rotates the robot horizontally.

In this connection, said event indicates that there is a sound or a face to be detected at each time, or the state in which the drive motor is rotated, and said stream indicates the event connected temporally continuous with, for example, a Kalman filter or others while correcting errors.

Here, the association module generates each speaker's auditory and face streams, based on thus extracted auditory, face, and motor events, and further generates an association stream associating these streams, and the attention control module, by attention controlling based on these streams, conducts planning of the drive motor control of the motor control module. Here, the association stream is the image including an auditory and a face streams, and an attention indicates a robot's auditory and/or visual “attention” to an object speaker, and the attention control means a robot paying attention to said speaker by changing its direction by a motor control module.

And the attention control module controls the drive motor of the motor control module based on said planning, and turns the robot's direction to the object speaker. Thereby, the robot faces in front of the object speaker, and the auditory module can accurately collect and localize the said speaker's speech with the microphone in the frontal direction where the sensitivity is high, as well as the face module can take said speaker's good pictures with the camera.

Therefore, by association of such auditory module, face module, and motor control module with the association module and the attention control module, robot's audition and vision are mutually complemented in their respective ambiguities, thereby so-called robustness is improved, and each speaker even among a plurality of speakers can be sensed, respectively. Also, even though either one of, for example, the auditory and the face events is lacking, since the association module can sense the object speaker based on the face event or the auditory event only, the motor control module can be controlled in real time.

Further, the auditory module performs speech recognition of the sound signals separated by sound source localization and sound source separation using a plurality of acoustic models, as described above, and integrates the speech recognition result by each acoustic model by the selector, and judges the most reliable speech recognition result. Thereby, accurate speech recognition in real time and real environments is possible by using a plurality of acoustic models, compared with conventional speech recognition, as well as speech recognition result is integrated by the selector by each acoustic model, the most reliable speech recognition result is judged, thereby more accurate speech recognition is possible.

In order also to achieve the above-mentioned objective, a third aspect of the robotics visual and auditory system of the present invention is provided with an auditory module which is provided at least with a pair of microphones to collect external sounds, and, based on sound signals from the microphones, determines a direction of at least one speaker by sound source separation and localization by grouping based on pitch extraction and harmonic sounds, a face module which is provided a camera to take images of a robot's front, identifies each speaker, and extracts his face event from each speaker's face recognition and localization, based on images taken by the camera, a stereo module which extracts and localizes a longitudinally long matter, based on a parallax extracted from images taken by a stereo camera, and extracts stereo event, a motor control module which is provided with a drive motor to rotate the robot in the horizontal direction, and extracts motor event, based on a rotational position of the drive motor, an association module which determines each speaker's direction, based on directional information of sound source localization of the auditory event and face localization of the face event, from said auditory, face, stereo, and motor events, generates an auditory stream, a face stream and a stereo visual stream by connecting said events in the temporal direction using a Kalman filter for determinations, and further generates an association stream associating these streams, and an attention control module which conduct an attention control based on said streams, and drive-controls the motor based on an action planning results accompanying the attention control, wherein the auditory module collects sub-bands having interaural phase difference (IPD) or interaural intensity difference (IID) within a predetermined range by an active direction pass filter having a pass range which, according to auditory characteristics, becomes minimum in the frontal direction, and larger as the angle becomes wider to the left and right, based on an accurate sound source directional information from the association module, and conducts sound source separation by restructuring a wave shape of a sound source, conducts speech recognition of the sound signals separated by sound sources separation using a plurality of acoustic models, integrates speech recognition results from each acoustic model by a selector, and judges the most reliable speech recognition result among the speech recognition results.

According to such third aspect, the auditory module conducts pitch extraction utilizing harmonic sound from the sound from the outside target collected by the microphone, thereby obtains the direction of each sound source, and extracts the auditory event. The face module extracts individual speakers' face events by identifying each speaker from face recognition and localization of each speaker by pattern recognition from the images photographed by the camera. Further, the stereo module extracts and localizes a longitudinally long matter, based on a parallax extracted from images taken by the stereo camera, and extracts stereo event. Further, the motor control module extracts motor event by detecting the robot's direction based on the rotating position of a drive motor which rotates the robot horizontally.

In this connection, said event indicates that there are sounds, faces, and longitudinally long matters to be detected at each time, or the state in which the drive motor is rotated, and said stream indicates the event connected temporally continuous with, for example, a Kalman filter or others while correcting errors.

Here, the association module generates each speaker's auditory, face, and stereo visual streams by determining each speaker's direction from the sound source localization of an auditory event and the face localization of a face event, based on thus extracted auditory, face, stereo, and motor events, and further generates an association stream associating these streams. Here, the association stream gives the image including an auditory, a face, and a stereo visual streams. In this case, the association module determines each speaker's direction based on the sound source localization by the auditory event and the face localization by the face event, that is, by the directional information of audition and directional information of vision, and, referring to the determined direction of each speaker, generates an association stream.

And the attention control module conducts attention controlling based on these streams, and motor drive control based on the planning result of action accompanying thereto. The attention control module controls the drive motor of the motor control module based on said planning, and turns the robot's direction to a speaker. Thereby, with the robot facing the speaker squarely as a target, the auditory module can accurately collect and localize said speaker's speech with the microphone in the frontal direction where the high sensitivity is expected, as well as a face module can take superbly said speaker's images with the camera.

Consequently, by determining each speaker's direction based on the directional information of sound source localization of the auditory stream and the speaker localization of the face stream by the combination of such auditory, face, stereo, and motor control modules with the association and the attention control modules, the ambiguities possessed by the robot's audition and vision, respectively, are complemented, so-called robustness is improved, and even each of a plurality of speakers can be accurately sensed.

Also, even if, for example, any of auditory, face, and stereo visual streams is lacking, since the attention control module can track the speaker as a target based on the rest of streams, the target direction is accurately held, and the motor control module can be controlled.

Here, the auditory module can conduct more accurate sound source localization by sound source localization with the face stream from the face module and the stereo visual stream from the stereo module taken into consideration, referring to the association stream from the association module. Since said auditory module collects the sub-bands with interaural phase difference (IPD) and interaural intensity difference (IID) within the range of pre-designed breadth, reconstructs the wave shape of the sound source, and effects sound source separation by the active direction pass filter having the pass range which becomes minimum in the frontal direction, and larger as the angle becomes larger to the left and right according to the auditory characteristics, based on the accurate sound source directional information from the association module, the more accurate sound source separation can be effected with the difference of sensitivity in direction taken into consideration, by adjusting pass range, that is, sensitivity according to said auditory characteristics. Further, said auditory module effects speech recognition by using a plurality of acoustic models, as mentioned above, based on sound signals conducted sound source localization and sound source separation by the auditory module, and it integrates the speech recognition result by each acoustic model by the selector, judges the most reliable speech recognition result, and outputs said speech recognition result associated with the corresponding speaker. Thereby, more accurate speech recognition compared with the conventional speech recognition is possible in real time, real environments by using a plurality of acoustic models, as well as the most reliable speech recognition result is judged by associating the speech recognition result by each acoustic model by the selector, and more accurate speech recognition becomes possible.

Here, in the second and the third aspects, when the speech recognition by the auditory module can not be effected, said attention control module turns said microphone and said camera toward the sound source of said sound signal, has the microphone recollect speech, and effects speech recognition by the auditory module again based on the sound signals conducted sound source localization and sound source separation by the auditory module to said sound. Thereby, since the robot's microphone of the auditory module and the camera of the face module face squarely said speaker, accurate speech recognition is possible.

Said auditory module preferably refers to the face event by the face module upon speech recognition. Also, the dialogue part may be provided which outputs the speech recognition result judged by said auditory module to outside. Further, the pass range of said active direction pass filter is preferably controllable on each frequency.

Said auditory module also considers the face stream from the face module upon speech recognition, by referring to the association stream from the association module. That is, since the auditory module effects speech recognition with regard to the face event localized by the face module, based on the sound signals from the sound source (speakers) localized and separated by the auditory module, more accurate speech recognition is possible. If the pass range of said active direction pass filter is controllable on each frequency, the accuracy of separation from the collected sounds is further improved, and thereby speech recognition is further improved.

### BRIEF DESCRIPITION OF THE DRAWINGS

FIG. 1 is a front view illustrating an outlook of a humanoid robot incorporated with the robot auditory apparatus according to the present invention as the first form of embodiment thereof.

FIG. 2 is a side view of the humanoid robot of FIG. 1.

FIG. 3 is a schematic enlarged view illustrating the makeup of a head part of the humanoid robot of FIG. 1.

FIG. 4 is a block diagram illustrating an example of electrical makeup of a robotics visual and auditory system of the humanoid robot of FIG. 1.

FIG. 5 is a view illustrating the function of an auditory module in the robotics visual and auditory system shown in FIG. 4.

FIG. 6 is a schematic diagonal view illustrating a makeup example of a speech recognition engine used in a speech recognition part of the auditory module in the robotics visual and auditory system of FIG. 4.

FIG. 7 is a graph showing the speech recognition ratio from the speakers in front and at ±60 degrees to the left and right by the speech recognition engine of FIG. 6, and (A) is the speaker in front, (B) is the speaker at ±60 degrees to the left, and (C) is the speaker at −60 degrees to the right.

FIG. 8 is a schematic diagonal view illustrating a speech recognition experiment in the robotics visual and auditory system shown in FIG. 4.

FIG. 9 is a view illustrating the results of a first example in order of speech recognition experiment in the robotics visual and auditory system of FIG. 4.

FIG. 10 is a view illustrating the results of a second example in order of speech recognition experiment in the robotics visual and auditory system of FIG. 4.

FIG. 11 is a view illustrating the results of a third example in order of speech recognition experiment in the robotics visual and auditory system of FIG. 4.

FIG. 12 is a view illustrating the results of a fourth example in order of speech recognition experiment in the robotics visual and auditory system of FIG. 4.

FIG. 13 is a view showing an extraction ratio in case of the controlled pass range width of an active direction pass filter with respect to the embodiment of the present invention, and the sound source is located in the direction of (a) 0, (b) 10, (c) 20, and (d) 30 degrees, respectively.

FIG. 14 is a view showing an extraction ratio in case of the controlled pass range width of an active direction pass filter with respect to the embodiment of the present invention, and the sound source is located in the direction of (a) 40, (b) 50, and (c) 60 degrees, respectively.

FIG. 15 is a view showing an extraction ratio in case of the controlled pass range width of an active direction pass filter with respect to the embodiment of the present invention, and the sound source is located in the direction of (a) 70, (b) 80, and (c) 90 degrees, respectively.

### BEST MODES FOR CARRYING OUT THE INVENTION

Hereinafter, the present invention will be described in detail with reference to suitable forms of embodiment thereof illustrated in the figures.

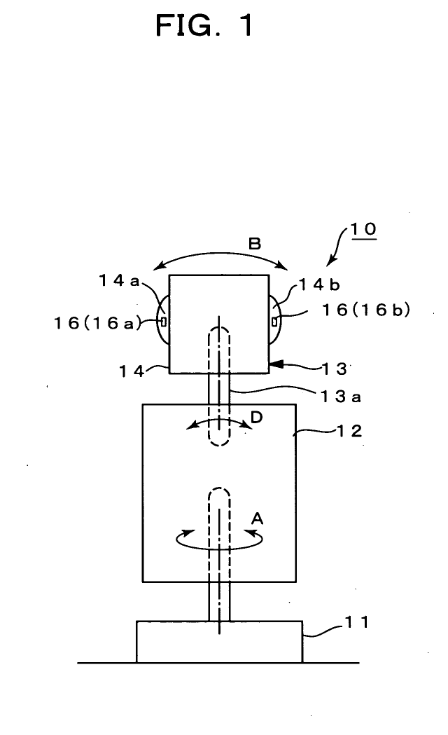

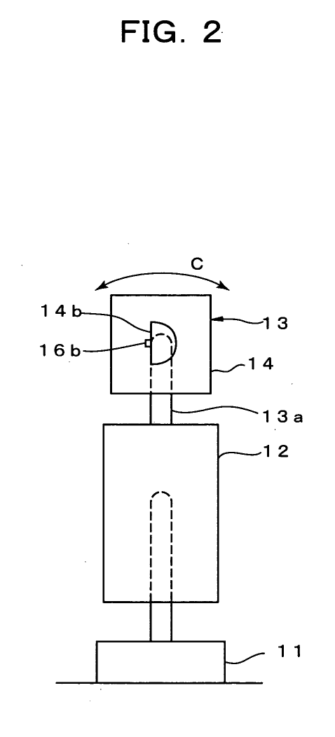

FIG. 1 and FIG. 2 illustrate an example of whole makeup of a humanoid robot with an upper body only for experiment provided with an embodiment of the robotics visual and auditory system according to the present invention, respectively. In FIG. 1, a humanoid robot 10 is made up as a robot of 4 DOF (degrees of freedom), and includes a base 11, a body part 12 supported rotatably around a uni-axis (vertical axis) on said base 11, and a head part 13 supported pivotally movable around three-axis (vertical, horizontal in the left and right, and horizontal in the back and forth directions) on said body part 12. The base 11 may be provided fixed, or movably with leg parts provided to it. The base 11 may also be put on a movable cart. The body part 12 is supported rotatably around the vertical axis with respect to the base 11 as shown by an arrow mark A in FIG. 1, and is rotatably driven by a drive means not illustrated, and is covered with a sound-proof cladding in case of this illustration.

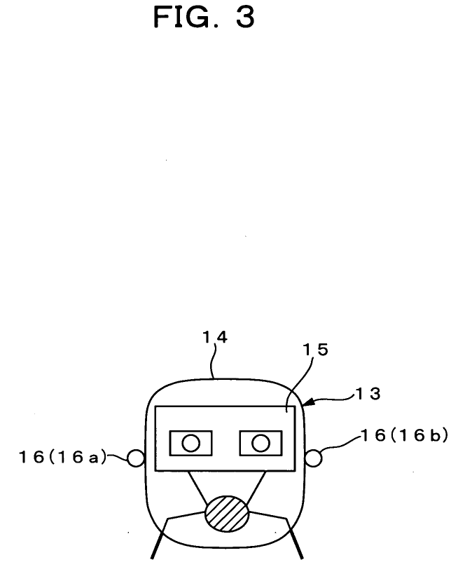

The head part 13 is supported via a connecting member 13a with respect to the body part 12, pivotally movable, as illustrated by an arrow mark B in FIG. 1, around the horizontal axis in the back and forth direction with respect to said connecting member 13a, and also pivotally movable, as illustrated by an arrow mark C in FIG. 2, around the horizontal axis in the left and right direction, and said connecting member 13a is supported pivotally movable, as illustrated by an arrow mark D in FIG. 1, around the horizontal axis further in the back and forth direction with respect to said body part 12, and each of them is rotatably driven by the not illustrated drive means in the directions A, B, C, and D of respective arrows. Here, said head part 13 is covered with a sound-proof cladding 14 as a whole as illustrated in FIG. 3, and is provided with a camera 15 in front as a visual apparatus for a robot vision, and a pair of microphones 16 (16a and 16b) at both sides as an auditory apparatus for a robot audition. Here, the microphones 16 may be provided in other positions of the head part 13 or the body part 12, not limited to the both sides of the head part 13.

The cladding 14 is made of, for example, such sound-absorbing synthetic resins as urethane resin, and the inside of the head part 13 is so made up as to be almost completely closed, and sound proofed. Here, the cladding of the body part 12 is also made of sound absorbing synthetic resins like the cladding 14 of the head part 13. The camera 15 has the known makeup, and is a commercial camera having 3 DOF (degrees of freedom) of, for example, so-called pan, tilt, and zoom. Here, the camera 15 is so designed as capable of transmitting stereo images with synchronization.

The microphones 16 are provided at both sides of the head part 13 so as to have directivity toward forward direction. Respective microphones 16a and 16b are provided, as illustrated in FIGS. 1 and 2, inside step parts 14a and 14b provided at both sides of the cladding 14 of the head part 13. The respective microphones 16a and 16b collect sounds from forward through a penetrated hole provided in the step parts 14a and 14b, and are sound proofed by appropriate means so not to pick up inside sounds of the cladding 14. Here, the penetrated hole provided in the step parts 14a and 14b is formed in respective step parts 14a and 14b so to penetrate from inside of the step parts 14a and 14b toward the forward of the head part. Thereby respective microphones 16a and 16b are made as so-called binaural microphones. Here, the cladding 14 close to the setting position of microphones 16a and 16b may be made like human outer ears. Here, the microphones 16 may include a pair of inner microphones provided inside the cladding 14, and can cancel the noise generated inside the robot 10, based on the inner sounds collected by said inner microphones.

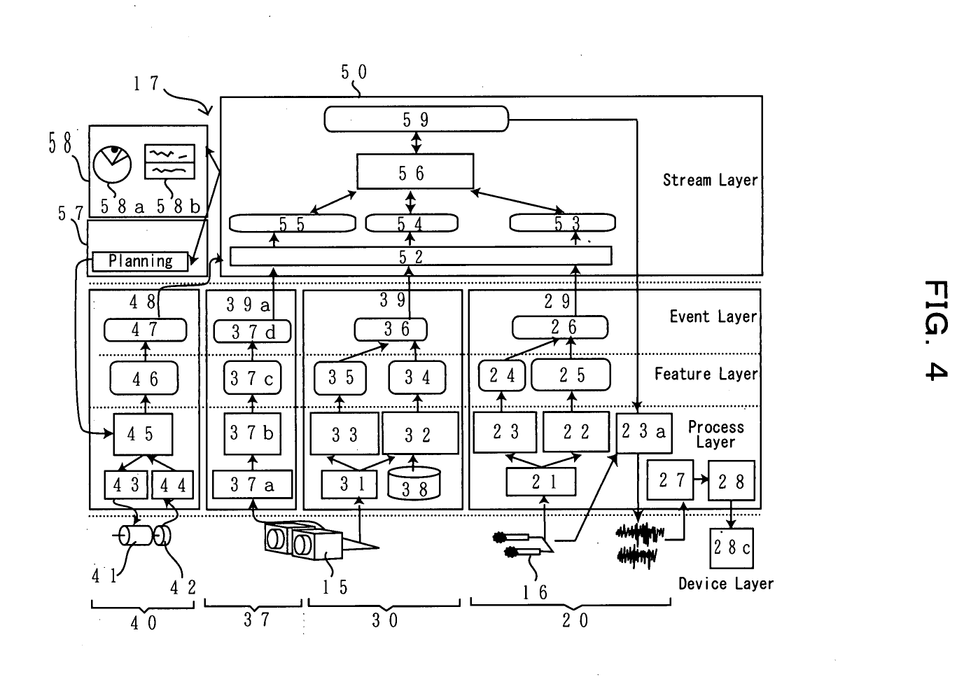

FIG. 4 illustrates an example of electrical makeup of a robotics visual and auditory system including said camera 15 and microphones 16. In FIG. 4, the robotics visual and auditory system 17 is made up with an auditory module 20, a face module 30, a stereo module 37, a motor control module 40, and an association module 50. Here, the association module 50 is so constitute as the server to execute treating according to the request from clients, where the clients for said server are the other modules, that is, the auditory module 20, the face module 30, the stereo module 37, and the motor control module 40. The server and the clients act unsynchronously to one another. Here, the server and each client are made up with personal computers, respectively, and further said each computer is made under the communication environment of, for example, TCP/IP protocol as LAN (Local Area Network) to each other. In this case, for the communication of events and streams of large data volume, high speed network capable of data exchange of giga bits is preferably applied to the robotics visual and auditory system 17, and, for control communication of time synchronization and the like, medium speed network is preferably applied to the robotics visual and auditory system 17. By transmitting such large data at high speed between each personal computer, the real time ability and scalability of the whole robot can be improved.

Each module, 20, 30, 37, 40, and 50 is made up dispersively in hierarchy, as such that a device, a process, a characteristic, and an event layers from the bottom in this order. The auditory module 20 is made up with a microphone 16 as a device layer, a peak extraction part 21, a sound source localization part 22, a sound source separation part 23 and an active direction pass filter 23a as a process layer, a pitch 24 and a sound source horizontal direction 25 as a feature layer (data), an auditory event formation part 26 as an event layer, and a speech recognition part 27 and a conversation part 28 as a process layer.

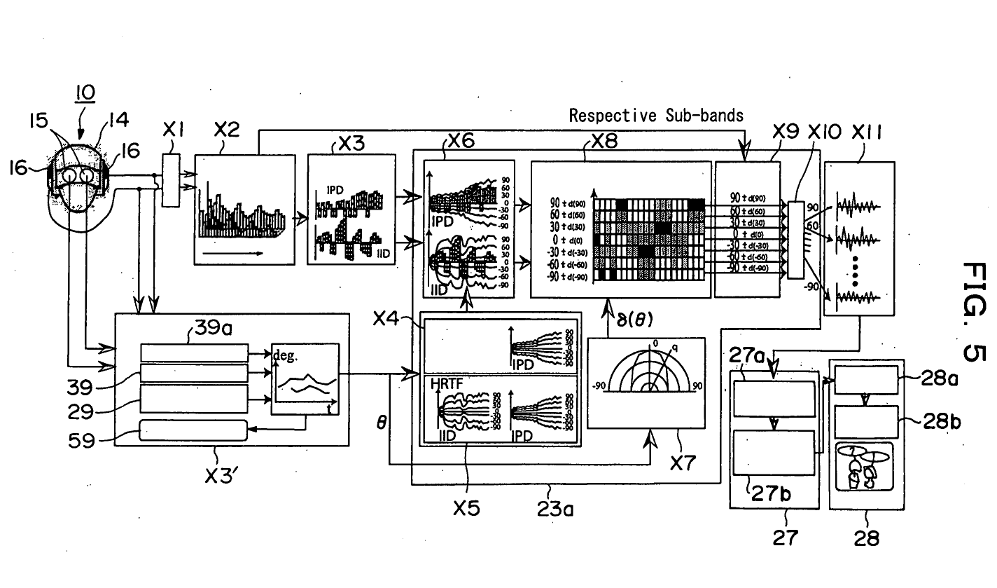

Here, the auditory module 20 acts as shown in FIG. 5. That is, in FIG. 5, the auditory module 20 frequency-analyses the sound signals from the microphones 16 sampled out by, for example, 48 kHz, 16 bits by FFT (High speed Fourier Transformation), as indicated with a mark X1, and generates spectra for the channels left and right, as indicated with a mark X2. The auditory module 20 also extracts a series of peaks from the channels left and right by the peak extraction part 21, and either identical or similar peaks from the channels left and right are made a pair. Peak extraction is performed using a band filter to pass only the data that satisfies three conditions (α−γ) where (α) the power is equal to, or higher than the threshold value, (β) local peaks, and (γ) the frequency, for example, between 90 Hz and 3 kHz to cut off both low frequency noise and high frequency band of low power. The threshold value measures background noise around, and is defined as the value with the sensitivity parameter, for example, 10 dB added thereto.

The auditory module 20 performs sound source separation utilizing the fact that each peak has harmonic structure. More concretely, the sound source separation part 23 extracts local peaks having harmonic structure in order from low frequency, and regards a group of the extracted peaks as one sound. Thus, the sound signal from each sound source is separated from mixed sounds. Upon sound source separation, the sound source localization part 22 of the auditory module 20 selects the sound signals of the same frequency from the channels left and right in respect to the sound signals from each sound source separated by the sound source separation part 23, and calculates IPD (Interaural Phase Difference) and IID (Interaural Intensity Difference). This calculation is performed at, for example, each 5 degrees. The sound source localization part 22 outputs the calculation result to the active direction pass filter 23a.

On the other hand, the active direction pass filter 23a generates the theoretical value of IPD (=Δφ′(θ)), as indicated with a mark X4, based on the direction θ of the association stream 59 calculated by the association module 50, as well as calculates the theoretical value of IID (=Δρ′(θ)). Here, the direction θ is calculated by real time tracking (Mark X3′) in the association module 50, based on face localization (face event 29), stereo vision (stereo visual event 39a), and sound source localization (auditory event 29).

Here, the calculations of the theoretical values IPD and IID are performed utilizing the auditory epipolar geometry explained below, and more concretely, the front of the robot is defined as 0 degree, and the theoretical values IPD and IID are calculated in the range of ±90 degrees. Here, the auditory epipolar geometry is necessary to obtain the directional information of the sound source without using HRTF. In stereo vision study, an epipolar geometry is one of the most general localization methods, and the auditory epipolar geometry is the application of visual epipolar geometry to audition. Since the auditory epipolar geometry obtains directional information utilizing the geometrical relationship, HRTF becomes unnecessary.

In the auditory epipolar geometry, the sound source is assumed to be infinitively remote, Δφ, θ, f, and v are defined as IPD, sound source direction, frequency, and sonic velocity, respectively, and r is defined as a radius of the robot's head part assumed as a sphere, then Equation (1) holds.

$$Δφ = \frac{2 π f}{v} \times r ( θ + sin θ ) \qquad ( 1 )$$

On the other hand, IPD Δφ′ and IID Δρ′ of each sub-band are calculated by the Equations (2) and (3) below, based on a pair of spectra obtained by FFT (Fast Fourier Transform).

$$\begin{matrix}{Δϕ}^{′} = arctan ( \frac{ [ {Sp}_{1} ]}{ℜ [ {Sp}_{1} ]} ) - arctan ( \frac{ [ {Sp}_{r} ]}{ℜ [ {Sp}_{r} ]} ) , and & ( 2 ) \\ {Δρ}^{′} = 20 {log}_{10} ( \frac{\vert {Sp}_{l} \vert}{\vert {Sp}_{r} \vert} ) , & ( 3 )\end{matrix}$$

where Sp₁, and Spᵣ are the spectra obtained at certain time from the microphones left and right 16a and 16b.

The active direction pass filter 23a selects the pass range δ(θs) of the active direction pass filter 23a corresponding to the stream direction θs according to the pass range function indicated with the mark X7. Here, the pass range function is such that becomes minimum at θ=0 degree, and larger at sides, as the sensitivity becomes maximum in the front of the robot (θ=0 degree), and lower at sides, as indicated with X7 of FIG. 5. This is to reproduce the audition characteristics that the localization sensitivity is maximum in the front direction, and lower as the angle becomes larger to the left and right. In this connection, the maximum localization sensitivity in the front direction is called an auditory fovea after the fovea found in the mammals' eye structure. As for the auditory fovea in the human case, the sensitivity of front localization is about ±2 degrees, and about ±8 degrees at about 90 degrees left and right.

The active direction pass filter 23a uses the selected pass range δ(θs), and extracts sound signals in the range from θL to θH. Here, it is defined as θL=θs−δ(θs), and θH=θs+δ(θs). Also, the active direction pass filter 23a assumes the theoretical values of IPD (=Δφ_{H}(θₛ))and IID (=Δρ_{H}(θₛ)) at θL and θH, by utilizing the stream direction θs for the Head Related Transfer Function (HRTF), as indicated with a mark X5. And the active direction pass filter 23a collects the sub-bands for which the extracted IPD (=Δφ_{E}) and IID (=Δρ_{E}) satisfy the conditions below within the angle range from θL to θH determined by the above-mentioned pass range δ(θ), as indicated with a mark X6, based on IPD (=Δφ_{E}(θ)) and IID (=Δρ_{E}(θ)) calculated for each sub-band based on the auditory epipolar geometry to the sound source direction θ, and on IPD (=Δφ_{H}(θ)) and IID (=Δρ_{H}(θ)) obtained based on HRTF.

Here, the frequency fₜₕ is the threshold value which adopts IPD or IID as the judgmental standard of filtering, and indicates the upper limit of the frequency for effective localization by IPD. Here, the frequency fₜₕ depends on the distance between the microphones of the robot 10, and, for example, about 1500 Hz in the present embodiment. That is,

ƒ<ƒₜₕ: Δφ_{E}(θ₁)≦Δφ′≦Δφ_{E}(θₕ)

ƒ≧ƒₜₕ: Δρ_{H}(θ₁)≦Δρ′≦Δρ_{H}(θₕ)

This means to collect sub-bands in case that IPD (=Δφ′) is within the range of IPD pass range δ(θ) by HRTF for the frequency lower than the pre-designed frequency fₜₕ, and in case that IID (=Δρ′) is within the range of IID pass range δ(θ) by HRTF for the frequency equal to or higher than the pre-designed frequency fₜₕ. Here, in general, IPD influences much in low frequency band region, and IID influences much in high frequency band region, and the frequency fₜₕ as its threshold value depends on the distance between the microphones.

The active direction pass filter 23a generates pass-sub-band direction, as indicated with a mark X8, by making up the wave shape by re-synthesizing sound signals from thus collected sub-bands, conducts filtering for each sub-band, as indicated with the mark X9, and extracts the separated sound (sound signal) from each sound source within the corresponding range, as indicated with the mark X11, by reverse frequency transformation IFFT (Inverse Fast Fourier Transform) indicated with the mark X10.

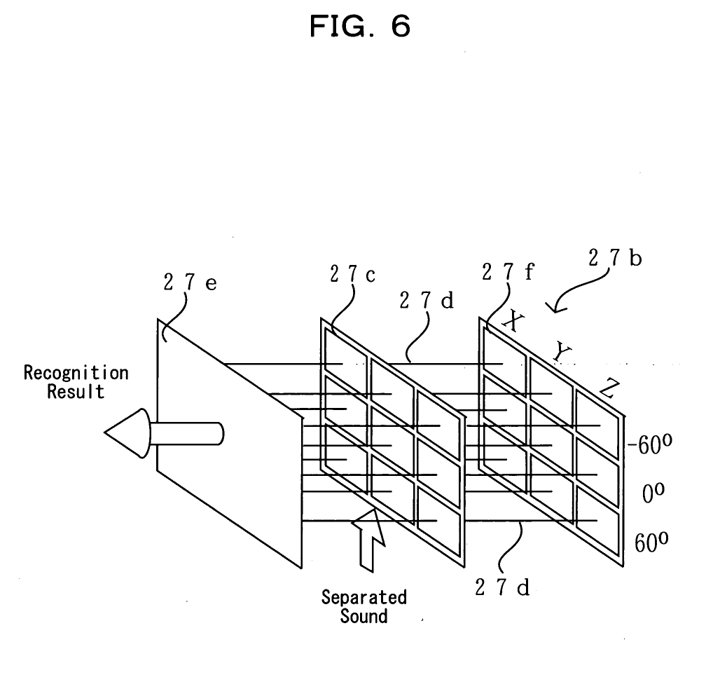

The speech recognition part 27 is made up with an own speech suppression part 27a and an automatic speech recognition part 27b, as shown in FIG. 5. The own speech suppression part 27a is such that removes the speeches from the speaker 28c of a dialogue part 28 mentioned below in each sound signal localized and separated by an auditory module 20, and picks up the sound signals only from outside. The automatic speech recognition part 27b is made up with a speech recognition engine 27c, acoustic models 27d, and a selector 27e, as shown in FIG. 6, and as the speech recognition engine 27c, the speech recognition engine “Julian”, for example, developed by Kyoto University can be used, thereby the words spoken by each speaker can be recognized.

In FIG. 6, the automatic speech recognition part 27b is made up so that three speakers, for example, two male (speakers A and C) and a female (speaker B) are recognized. Therefore, the automatic speech recognition part 27b is provided with acoustic models 27d with respect to each direction of each speaker. In case of FIG. 6, the acoustic models 27d are made up by combination of the speeches and their directions spoken by each speaker with respect to each of A, B, and C, and a plurality of kinds, 9 kinds in this case of acoustic models 27d are provided.

The speech recognition engine 27c executes nine speech recognition processes in parallel, and uses said nine acoustic models 27d for that. The speech recognition engine 27c executes speech recognition processes using the nine acoustic models 27d for the sound signals input in parallel to each other, and these speech recognition results are output to the selector 27e. The selector 27e integrates all the results of speech recognition processes from each acoustic model 27d, judges the most reliable result of speech recognition processes by, for example, majority vote, and outputs said result of speech recognition processes.

Here, the Word Correct Ratio to acoustic models 27d of a certain speaker is explained by concrete experiments. First, in a room of 3 m×3 m, three speakers are located at a position lm away from the robot 10, and in the direction of 0 and ±60 degrees, respectively. Next, as speech data for acoustic models, the speech signals of 150 words such as colors, numeric characters, and foods, spoken by two males and one female are output from the speakers, and collected with the robot 10's microphones 16a and 16b. Here, upon collecting each word, three patterns for each word were recorded, such as the speech from one speaker only, the speech output at the same time from two speakers, and the speech simultaneously output from three speakers. The recorded speech signals were speech separated by the above-mentioned active direction pass filter 23a, each speech data was extracted, arranged for each speaker and direction, and a training set for acoustic models were prepared.

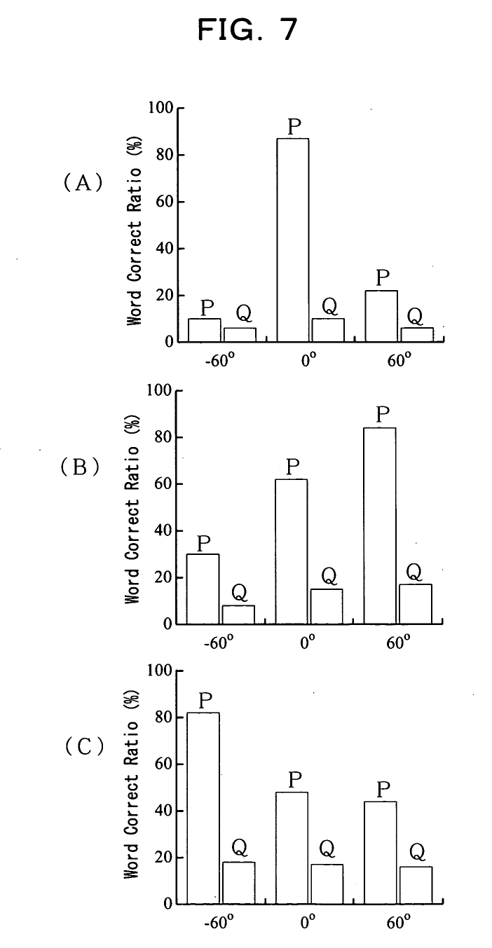

In each acoustic model 27d, the speech data were prepared for nine kinds of speech recognitions for each speaker and each direction, using a triphone, and HTK (Hidden Marcov Model tool kit) 27f in each training set. Using thus obtained speech data for acoustic models, the Word Correct Ratio for a specific speaker to the acoustic models 27d was studied by experiment, and the result was as shown in FIG. 7. FIG. 7 is a graph showing the direction on the abscissa and the Word Correct Ratio on the ordinate, P indicates the speaker's (A) speech, Q the others' (B and C) speeches. For the speaker A's acoustic model, in case that the speaker A is located in front of the robot 10 (FIG. 7(A)), the Word Correct Ratio was over 80% in front (o degree), and in case that the speaker A is located at 60 degrees to the right or −60 degrees to the left, the Word Correct Ratio was less lowered by the difference of direction than of speakers, as shown in FIG. 7(B) or (C), and when both the speaker and the direction are appropriate, the Word Correct Ratio was found to be over 80%.

Taking this result into consideration, utilizing the fact that the sound source direction is known upon speech recognition, the selector 27e uses the cost function V (pe) given by Equation (5) below for integration.

$$V ( {p}_{e} ) = ( {\sum }_{d} r ( {p}_{e} , d ) \cdot v ( {p}_{e} , d ) + {\sum }_{d} r ( p , {d}_{e} ) \cdot v ( p , {d}_{e} ) - r ( {p}_{e} , {d}_{e} ) ) \cdot {P}_{v} ( {p}_{e} ) \\ v ( p , d ) = \{ \begin{matrix}1 & if & Res ( p , d ) = Res ( {p}_{e} , {d}_{e} ) \\ 0 & if & Res ( p , d ) \neq Res ( {p}_{e} , {d}_{e} )\end{matrix} \qquad ( 5 )$$

where v (p, d) and Res (p, d) are defined as the Word Correct Ratio and the recognition result of the input speech, respectively, for the acoustic model of the speaker p and the direction d, de as the sound source direction by real-time tracking, that is θ in FIG. 5, and pₑ as the speaker to be evaluated.

Said v (pₑ, dₑ) is the probability generated by a face recognition module, and it is always 1.0 for the case that the face recognition is impossible. And the selector 27e outputs the speaker pₑ having the maximum value of the cost function V(pₑ) and the recognition result Res (p, d). In this case, since the selector 27e can specify the speaker by referring to the face event 39 by the face recognition from the face module 30, the robustness of speech recognition can be improved.

Here, if the maximum value of the cost function V(pe) is either 1.0 or lower, or close to the second largest value, then it is judged that speech recognition is impossible, for speech recognition failed, or the candidates failed to be selected to one, and this result is output to the dialogue part 28 mentioned below. The dialogue part 28 is made up with a dialogue control part 28a, a speech synthesis part 28b, and a speaker 28c. The dialogue control part 28a generates speech data for the object speaker, by being controlled by an association module 60 mentioned below, based on the speech recognition result from the speech recognition part 27, that is, the speaker pe and the recognition result Res (p, d), and outputs to the speech synthesis part 28b. The speech synthesis part 28b drives the speaker 28c based on the speech data from the dialogue control part 28a, and speaks out the speech corresponding to the speech data. Thereby, the dialogue part 28, based on the speech recognition result from the speech recognition part 27, in case, for example, the speaker A says “1” as a favorite number, speaks such speech as “Mr. A said ‘1’.” to said speaker A, as the robot 10 faces squarely to said speaker A.

Here, if the speech recognition part 27 outputs that the speech recognition failed, then the dialogue part 28 asks said speaker A, “Is your answer 2 or 4?”, as the robot 10 faces squarely to said speaker A, and tries again the speech recognition for the speaker A's answer. In this case, since the robot 10 faces squarely to said speaker A, the accuracy of the speech recognition is further improved.

Thus, the auditory module 20 specifies at least one speaker (speaker identification) by the pitch extraction, the sound source separation and the sound source localization based on the sound signals from the microphones 16, extracts its auditory event, and transmits to the association module 50 via network, as well as confirms speech recognition result of the speaker from speech by the dialogue part 28 by performing speech recognition of each speaker.

Here, actually, since the sound source direction θₛ is the function of time t, the continuity in the temporal direction has to be considered in order to keep extracting the specific sound source, but, as mentioned above, the sound source direction is obtained by the stream direction θₛ from real-time tracking. Thereby, since all events are expressed in the expression taking into consideration the streams as temporal flow by real-time tracking, the directional information from a specific sound source can be obtained continuously by keeping attention to one stream, even in case that a plurality of sound sources co-exist simultaneously, or sound sources and the robot itself are moving. Further, since stream is used also to integrate audiovisual events, the accuracy of sound source localization is improved by sound source localization by auditory event referring to face event.

The face module 30 is made up with a camera 15 as device layer, a face finding part 31, a face recognition part 32, and a face localization part 33 as process layer, a face ID 34, and a face direction 35 as feature layer (data), and a face event generation part 36 as event layer. Thereby, the face module 30 detects each speaker's face by, for example, skin color extraction by the face finding part 31, based on the image signals from the camera 15, searches the face in the face database 38 pre-registered by the face recognition part 32, determines the face ID 34, and recognizes the face, as well as determines (localizes) the face direction 35 by the face localization part 33.

Here, the face module 30 conducts the above-mentioned treatments, that is, recognition, localization, and tracking for each of the faces, when the face finding part 31 found a plurality of faces from image signals. In this case, since the size, direction, and brightness of the face found by the face finding part 31 often change, the face finding part 31 conducts face region detection, and accurately detects a plurality of faces within 200 msec by the combination of pattern matching based on skin color extraction and correlation operation.

The face localization part 33 converts the face position in the image plane of two dimensions to three dimensional space, and obtains the face position in three dimensional space as a set of directional angle θ, height φ, and distance r. The face module 30 generates face event 39 by the face event generation part 36 from the face ID (name) 34 and the face direction 35 for each face, and transmits to the association module 50 via network.

The face stereo module 37 is made up with a camera 15 as device layer, a parallax image generation part 37a and a target extraction part 37b as process layer, a target direction 37c as feature layer (data), and a stereo event generation part 37d as event layer. Thereby, the stereo module 37 generates parallax images from image signals of both cameras 15 by the parallax image generation part 37a, based on image signals from the cameras 15. Next, the target extraction part 37b divides regions of parallax images, and as the result, if a longitudinally long matter is found, the target extraction part 37b extracts it as a human candidate, and determines (localizes) its target direction 37c. The stereo event generation part 37d generates stereo event 39a based on the target direction 37c, and transmits to the association module 50 via network.

The motor control module 40 is made up with a motor 41 and a potentiometer 42 as device layer, a PWM control circuit 43, an AD conversion circuit 44, and a motor control part 45 as process layer, a robot direction 46 as feature layer (data), and a motor event generation part 47 as event layer. Thereby, in the motor control module 40, the motor control part 45 drive-controls the motor 41 based on command from the attention control module 57 (described later) via the PWM control circuit 43. The motor control module 40 also detects the rotation position of the motor 41 by the potentiometer 42. This detection result is transmitted to the motor control part 45 via the AD conversion circuit 44. The motor control part 45 extracts the robot direction 46 from the signals received from the AD conversion circuit 44. The motor event generation part 47 generates motor event 48 consisting of motor directional information, based on the robot direction 46, and transmits to the association module 50 via network.

The association module 50 is ranked hierarchically above the auditory module 20, the face module 30, the stereo module 37, and the motor control module 40, and makes up stream layer above event layers of respective modules 20, 30, 37, and 40. Concretely, the association module 50 is provided with the absolute coordinate conversion part 52, the associating part 56 to dissociate these streams 53, 54, and 55, and further with an attention control module 57 and a viewer 58. The absolute coordinate conversion part 52 generates the auditory stream 53, the face stream 54, and the stereo visual stream 55 by synchronizing the unsynchronous event 51 from the auditory module 20, the face module 30, the stereo module 37, and the motor control module 40, that is, the auditory event 29, the face event 39, the stereo event 39a, and the motor event 48. The absolute coordinate conversion part 52 associates the auditory stream 53, the face stream 54, and the stereo visual stream 55 to generate the association stream 59 or to each stream 53, 54, and 55 to generate the association stream 59, or dissociate these streams 53, 54, and 55.

The absolute coordinate conversion part 52 synchronizes the motor event 48 from the motor control module 40 to the auditory event 29 form the auditory module 20, the face event 39 from the face module 30, and the stereo event 39a from the stereo module 37, as well as, by converting the coordinate system to the absolute system by the synchronized motor event with respect to the auditory event 29, the face event 39, and the stereo event 39a, generates the auditory stream 53, the face stream 54, and the stereo visual stream 55. In this case, the absolute coordinate conversion part 52, by connecting to the same speaker's auditory, face, and stereo visual streams, generates an auditory stream 53, a face stream 54, and a stereo visual stream 55.

The associating part 56 associates or dissociates streams, based on the auditory stream 53, the face stream 54, and the stereo visual stream 55, taking into consideration the temporal connection of these streams 53, 54, and 55, and generates an association stream, as well as dissociates the auditory stream 53, the face stream 54, and the stereo visual stream 55 which make up the association stream 59, when their connection is weakened. Thereby, even while the target speaker is moving, the speaker's move is predicted, and by generating said streams 53, 54, and 55 within the angle range of its move range, said speaker's move can be predicted and tracked.

The attention control module 57 conducts an attention control for planning of the drive motor control of the motor control module 40, and in this case, referring preferentially to the association stream 59, the auditory stream 53, the face stream 54, and the stereo visual stream 55 in this order, conducts the attention control. The attention control module 57 conducts the motion planning of the robot 10, based on the states of the auditory stream 53, the face stream 54, and the stereo visual stream 55, and also on the presence or absence of the association stream 59, transmits motor event as motion command to the motor control module 40 via network, if the motion of the drive motor 41 is necessary. Here, the attention control in the attention control module 57 is based on continuity and trigger, tries to maintain the same state by continuity, to track the most interesting target by trigger, selects the stream to be turned to attention, and tries tracking. Thus, the attention control module 57 conducts the attention control, planning of the control of the drive motor 41 of the motor control module 40, generates motor command 64a based on the planning, and transmits to the motor control module 40 via network 70. Thereby, in the motor control module 40, the motor control part 45 conducts PWM control based on said motor command 64a, rotation-drives the drive motor 41, and turns the robot 10 to the pre-designed direction.

The viewer 58 displays thus generated each stream 53, 54, 55, and 57 on the server screen, and more concretely, display is by radar chart 58a and stream chart 58b. The radar chart 58a indicates the state of stream at that instance, or in more details, the visual angle of a camera and sound source direction, and the stream chart 58b indicates association stream (shown by solid line) and auditory, face, and stereo visual streams (thin lines).

The humanoid robot 10 in accordance with embodiments of the present invention is made up as described above, and acts as below.
First, Speakers are located lm in front of the robot 10, in the directions diagonally left (θ=+60 degrees), front (θ=0 degree), and right (θ=−60 degrees), and the robot 10 asks questions to three speakers by the dialogue part 28, and each speaker answers at the same time to questions. The microphones 16 of the robot 10 picks up speeches from said speakers, the auditory module 20 generates the auditory event 29 accompanied by sound source direction, and transmits to the association module 50 via network. Thereby, the association module 50 generates the auditory stream 53 based on the auditory event 29.

The face module 30 generates the face event 39 by taking in the face image of the speaker by a camera 15, searches said speaker's face in the face database 38, and conducts face recognition, as well as transmits the face ID 24 and images as its result to the association module 50 via network. Here, if said speaker's face is not registered in the face database 38, the face module 30 transmits that fact to the association module 50 via network. Therefore, the association module 50 generates an association stream 59 based on the auditory event 29, the face event 39, and the stereo event 39a.

Here, the auditory module 20 localizes and separates each sound source (speakers X, Y, and Z) by the active direction pass filter 23a utilizing IPD by the auditory epipolar geometry, and picks up separated sound (sound signals). The auditory module 20 uses the speech recognition engine 27c by its speech recognition part 27, recognizes each speaker X, Y, and Z's speech, and outputs its result to the dialogue part 28. Thereby, the dialogue part 28 speaks out the above-mentioned answers recognized by the speech recognition part 27, as the robot 10 faces squarely to each speaker. Here, if the speech recognition part 27 can not recognize speech correctly, the question is repeated again as the robot 10 faces squarely to the speaker, and based on its answer, speech recognition is tried again.

Thus, by the humanoid robot 10 in accordance with embodiments of the present invention, the speech recognition part 27 can recognize speeches of a plurality of speakers who speak at the same time by speech recognition using the acoustic model corresponding to each speaker and direction, based on the sound (sound signals) localized and separated by the auditory module 20.

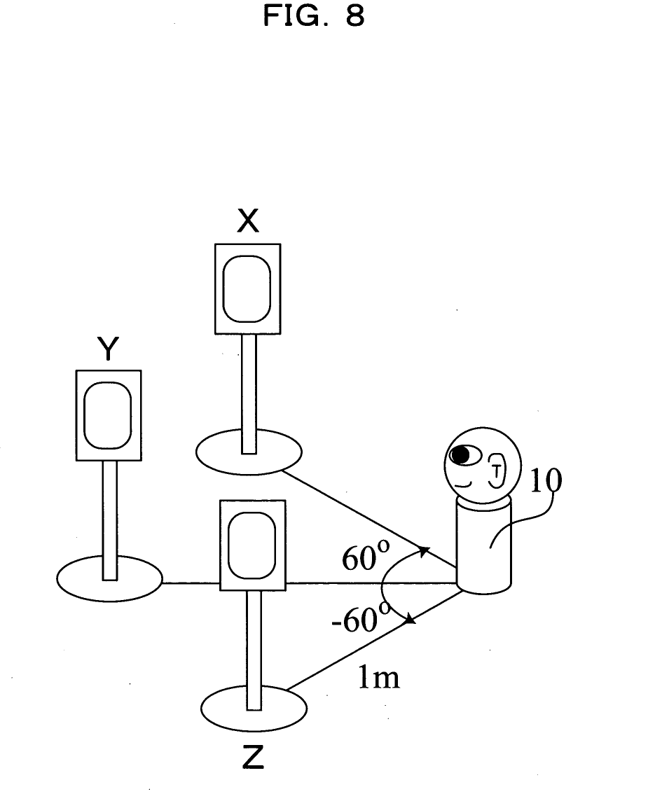

The action of the speech recognition part 27 is evaluated below by experiments. In these experiments, as shown in FIG. 8, speakers X, Y, and Z were located in line lm in front of the robot 10, in the directions diagonally left (θ=+60 degrees), front (θ=0 degree), and right (θ=−60 degrees). Here, in the experiments, electric speakers replaced human speakers, respectively, and in their fronts were put human speakers' photographs. Here, the same speakers were used as when acoustic model was prepared, and the speech spoken from each speaker was regarded as that of each human speaker of the photograph.

The speech recognition experiments were conducted based on the scenario below.
1. The robot 10 asks questions to three speakers X, Y, and Z.
2. Three speakers X, Y, and Z answer to the question at the same time.
3. The robot 10 localizes sound source and separates based on three speakers X, Y, and Z's mixed speeches, and further conducts speech recognition of each separated sound.
4. The robot 10 answers to said speaker in turn in the state of facing squarely to each speaker X, Y, and Z.
5. When the robot 10 judges that it could not speech recognize correctly, it repeats the question again facing squarely to said speaker, and speech recognizes again based on its answer.

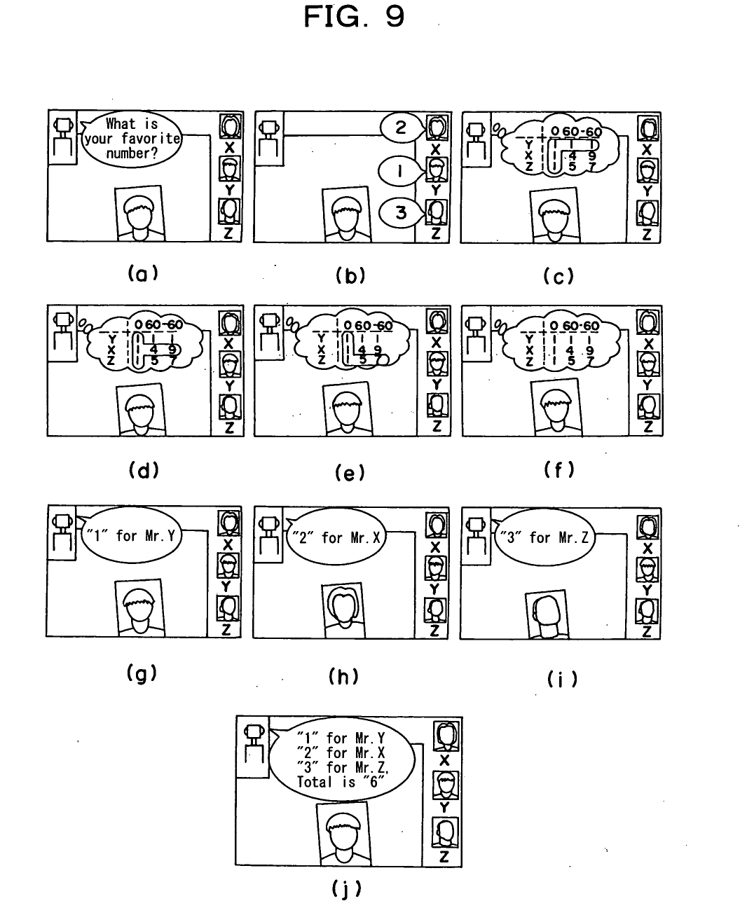

The first example of the experimental result from the above-mentioned scenario is shown in FIG. 9.
1. The robot 10 asks, “What is your favorite number?” (Refer to FIG. 9(a).)
2. From the electric speakers as speakers X, Y, and Z, the speeches are spoken reading out arbitrary numbers among 1 to 10 at the same time. For example, as shown in FIG. 9(b), Speaker X says “2”, Speaker Y “1”, and Speaker Z “3”.
3. The robot 10, in the auditory module 20, localizes the sound source and separates by the active direction pass filter 23a, based on the sound signals collected by its microphones 16, and extracts the separated sounds. And, based on the separated sounds corresponding to each speaker X, Y, and Z, the speech recognition part 27 uses nine acoustic models for each speaker, executes speech recognition process at the same time, and conducts its speech recognition.
4. In this case, the selector 27e of the speech recognition part 27 evaluates speech recognition on the assumption that the front is Speaker Y (FIG. 9(c)), evaluates speech recognition on the assumption that the front is Speaker X (FIG. 9(d)), and finally, evaluates speech recognition on the assumption that the front is Speaker Z (FIG. 9(e)).
5. And the selector 27e, integrating the speech recognition results as shown in FIG. 9(f), decides the most suitable speaker's name (Y) and the speech recognition result (“1”) for the robot's front (θ=0 degree), and outputs to the dialogue part 28. Thereby, as shown in FIG. 9(g), the robot 10 answers, “‘1’ for Mr. Y”, facing squarely Speaker Y.
6. Next, for the direction of diagonally left (θ=+60 degrees), the same procedure as above is executed, and, as shown in FIG. 9(h), the robot 10 answers, “‘2’ for Mr. X”, facing squarely Speaker X. Further, for the direction of diagonally right (θ=−60 degrees), the same procedure as above is executed, and, as shown in FIG. 9(i), the robot 10 answers, “‘3’ for Mr. Z”, facing squarely Speaker Z.

In this case, the robot 10 could speech recognize all correctly for each speaker X, Y, and Z's answer. Therefore, in case of simultaneous speaking, the effectiveness of sound source localization, separation, and speech recognition was shown in the robotics visual and auditory system 17 using a microphones 16 of the robot 10.

In this connection, as shown in FIG. 9(j), the robot 10, not facing squarely each speaker, may answer the sum of the numbers answered by each speaker X, Y, and Z, such that, “‘1’ for Mr. Y, ‘2’ for Mr. X, ‘3’ for Mr. Z, the total is ‘6’.”

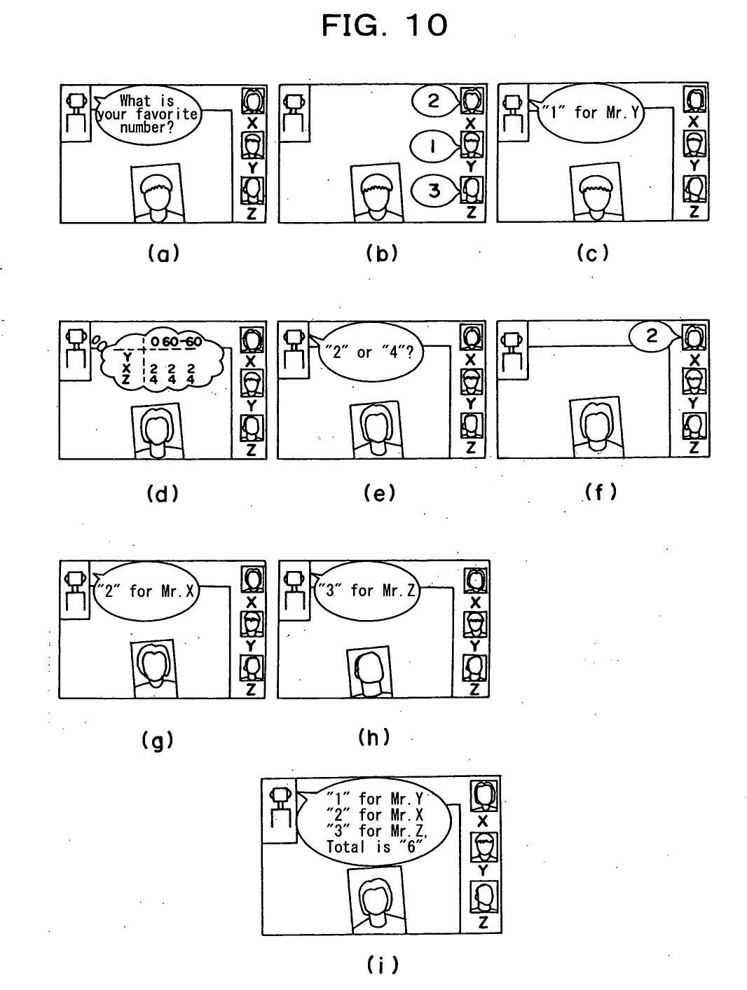

The second example of the experimental result from the above-mentioned scenario is shown in FIG. 10.
1. Like the first example shown in FIG. 9, the robot 10 asks, “What is your favorite number?” (Refer to FIG. 10(a).), and from the electric speakers as speakers X, Y, and Z, the speeches are spoken, as shown in FIG. 10(b), ‘2’ for Speaker X, ‘1’ for Speaker Y, and ‘3’ for Speaker Z.
2. The robot 10, similarly in the auditory module 20, localizes sound source and separates by the active direction pass filter 23a, based on the sound signals collected by its microphones 16, extracts the separated sounds, and, based on the separated sounds corresponding to each speaker X, Y, and Z, the speech recognition part 27 uses nine acoustic models for each speaker, executes speech recognition process at the same time, and conducts its speech recognition. In this case, the selector 27e of the speech recognition part 27 can evaluate speech recognition for Speaker Y in front, as shown in FIG. 10(c).
3. On the other hand, the selector 27e can not determine whether ‘2’ or ‘4’, as shown in FIG. 10(d), for Speaker X at +60 degrees.
4. Therefore, the robot 10 asks, “Is it 2 or 4?”, as shown in FIG. 10(e), facing squarely Speaker X at +60 degrees.
5. To this question, the answer ‘2’ is spoken from the electric speaker as Speaker X, as shown in FIG. 10(f). In this case, since speaker X is located in front of the robot 10, the auditory module 20 localizes sound source and separates correctly for Speaker X's answer, the speech recognition part 27 recognizes the speech correctly, and outputs Speaker X's name and the speech recognition result ‘2’ to the dialogue part 28. Thereby, the robot 10 answers, “‘2’ for Mr. X.” to Speaker X, as shown in FIG. 10(g).
6. Next, the similar process is executed for Speaker Z, and its speech recognition result is answered to Speaker Z. That is, as shown in FIG. 10(h), the robot 10 answers, “‘3’ for Mr. Z”, facing squarely Speaker Z.

Thus, the robot 10 could recognize all speech correctly by re-question for each speaker X, Y, and Z's answer. Therefore, it was shown that the ambiguity of speech recognition by deterioration of separation accuracy by the effect of auditory fovea on sides was dissolved with the robot 10 facing squarely the speaker on sides and asking again, the accuracy of sound source separation was improved, and the accuracy of speech recognition was also improved.

In this connection, as shown in FIG. 10(i), the robot 10, after correct speech recognition for each speaker, may answer the sum of the numbers answered by each speaker X, Y, and Z, such that, “‘1’ for Mr. Y, ‘2’ for Mr. X, ‘3’ for Mr. Z, the total is ‘6’.”

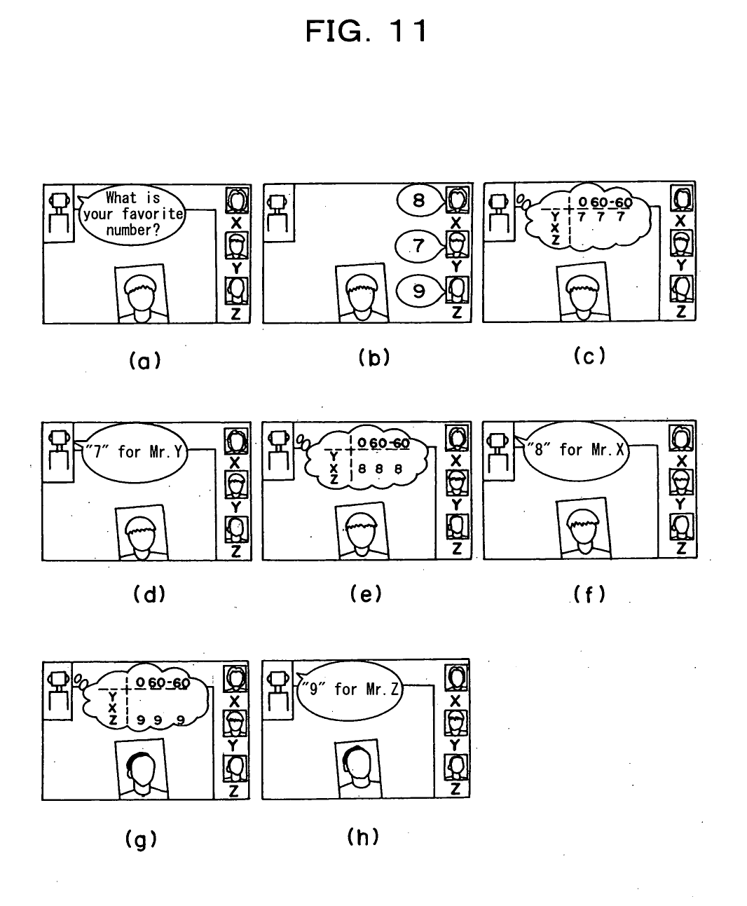

FIG. 11 shows the third example of the experimental result from the above-mentioned scenario.
1. In this case also, like the first example shown in FIG. 9, the robot 10 asks, “What is your favorite number?” (Refer to FIG. 10(a).), and from the electric speakers as speakers X, Y, and Z, the speeches are spoken, as shown in FIG. 10(b), ‘8’ for Speaker X, ‘7’ for Speaker Y, and ‘9’ for Speaker Z.
2. The robot 10, similarly in the auditory module 20, localizes sound source and separates by the active direction pass filter 23a, based on the sound signals collected by its microphones 16, and referring to the stream direction θ by real-time tracking (refer to X3′) and each speaker's face event, extracts the separated sounds, and, based on the separated sounds corresponding to each speaker X, Y, and Z, the speech recognition part 27 uses nine acoustic models for each speaker, executes speech recognition process at the same time, and conducts its speech recognition. In this case, since the probability is high for the front speaker Y as Speaker Y based on face event, the selector 27e of the speech recognition part 27 takes it into consideration, as shown in FIG. 10(c), upon integration of the speech recognition results by each acoustic model. Thereby, more accurate speech recognition can be performed. Therefore, the robot 10 answers, “‘7’ for Mr. X”, as shown in FIG. 11(d), to Speaker X.
3. On the other hand, if the robot 10 changes its direction and faces squarely Speaker X located at +60 degrees, the probability is high that the front speaker X in this case is Speaker X based on face event, so that similarly the selector 27e takes it into consideration, as shown in FIG. 11(e). Therefore, the robot 10 answers “‘8’ for Mr. Y” to Speaker X, as shown in FIG. 11(f).
4. Next, the similar process is executed for Speaker Z, and the selector 27e answers its speech recognition result to Speaker Z, as shown in FIG. 11(g), that is, as shown in FIG. 11(h), the robot 10 answers, “‘9’ for Mr. Z”, facing squarely Speaker Z.

Thus, the robot 10 could recognize all speech correctly for each speaker X, Y, and Z's answer, based on the speaker's face recognition facing squarely each speaker, and referring to the face event. Thus, since the speaker can be identified by face recognition, it was shown that more accurate speech recognition was possible. Especially, in case that utilization in specific environment is assumed, if face recognition accuracy close to about 100% is attained by face recognition, the face recognition information can be utilized as highly reliable information, and the number of acoustic model 27d used in the speech recognition engine 27c of the speech recognition part 27 can be reduced, thereby the higher speed and more accurate speech recognition is possible

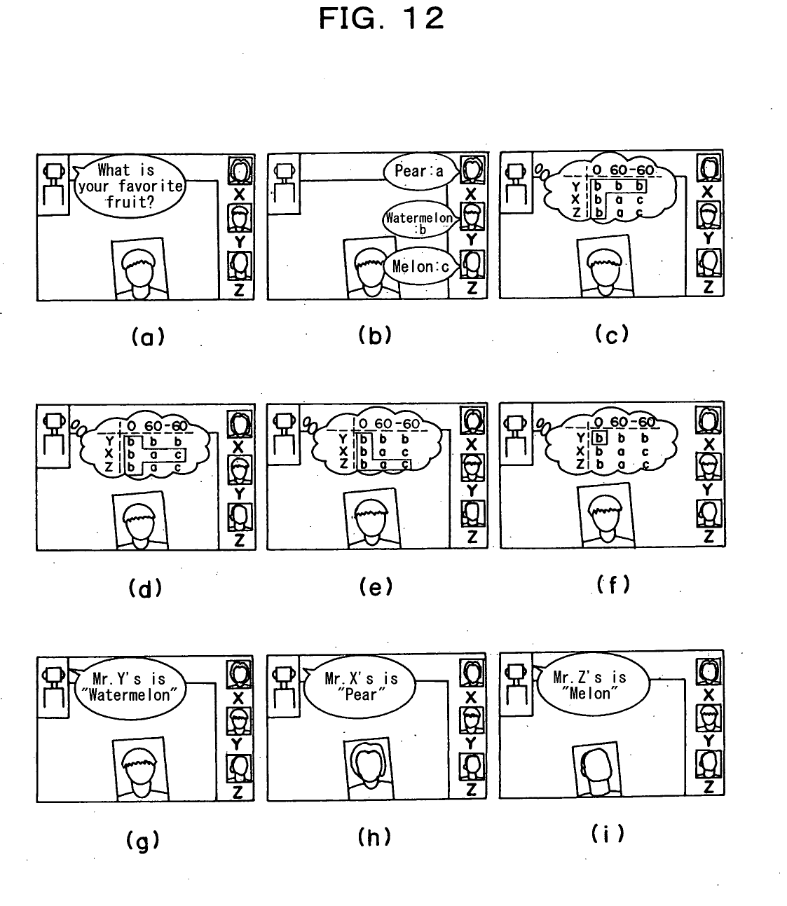

FIG. 12 shows the fourth example of the experimental result from the above-mentioned scenario.
1. The robot 10 asks, “What is your favorite fruit?” (Refer to FIG. 12(a).), and from the electric speakers as speakers X, Y, and Z, as shown, for example in FIG. 12(b), Speaker X says ‘pear’, Speaker Y ‘watermelon’, and Speaker Z ‘melon’.
2. The robot 10, in the auditory module 20, localizes sound source and separates by the active direction pass filter 23a, based on the sound signals collected by its microphones 16, and extracts the separated sounds. And, based on the separated sounds corresponding to each speaker X, Y, and Z, the speech recognition part 27 uses nine acoustic models for each speaker, executes speech recognition process at the same time, and conducts its speech recognition.
3. In this case, the selector 27e of the speech recognition part 27 evaluates speech recognition on the assumption that the front is Speaker Y (FIG. 12(c)), evaluates speech recognition on the assumption that the front is Speaker X (FIG. 12(d)), and finally, evaluates speech recognition on the assumption that the front is Speaker Z (FIG. 12(e)).
4. And the selector 27e, integrating the speech recognition results as shown in FIG. 12(f), decides the most suitable speaker's name (Y) and the speech recognition result (“watermelon”) for the robot's front (θ=0 degree), and outputs to the dialogue part 28. Thereby, as shown in FIG. 9(g), the robot 10 answers, “Mr. Y's is ‘watermelon’.”, facing squarely Speaker Y.
5. Followed by the similar processes executed for each speaker X and Z, the speech recognition results are answered for each speaker X and Z. That is, as shown in FIG. 12(h), the robot 10 answers, “Mr. X's is ‘pear’.”, facing squarely Speaker X, and further, as shown in FIG. 12(i), the robot 10 answers, “Mr. Z's is ‘melon’.”, facing squarely Speaker Z.

In this case, the robot 10 could conduct all speech recognition correctly for each speaker X, Y, and Z's answer. Therefore, it is understood that the words registered in the speech recognition engine 27c are not limited to numbers, but speech recognition is possible for any words registered in advance. Here, in the speech recognition engine 27c used in experiments, about 150 words were registered, but the speech recognition ratio is somewhat lower for the words with more syllables.

In the above-mentioned embodiments, the robot 10 is so made up as to have 4 DOF (degree of freedom) in its upper body, but, not limited to this, an robotics visual and auditory system of the present invention may be incorporated into a robot made up to perform arbitrary motion. Also, in the above-mentioned embodiments, the case was explained in which a robotics visual and auditory system of the present invention was incorporated into a humanoid robot 10, but, not limited to this, it is obvious that it can be incorporated into various animaloid robots such as a dog-type, or any other robots of other types.

Also in the explanation above, as shown in FIG. 4, a makeup example was explained in which a robotics visual and auditory system 17 is provided with a stereo module 37, but a robotics visual and auditory system may be made up without the stereo module 37. In this case, an association module 50 is so made up as to generate each speaker's auditory stream 53 and face stream 54, based on the auditory event 29, the face event 39, and the motor event 48, and further, by associating these auditory stream 53 and face stream 54, to generate an association stream 59, and in an attention control module 50, to execute attention control based on these streams.

Further in the above-mentioned explanation, an active direction pass filter 23a controlled pass range width for each direction, and the pass range width was made constant regardless of the frequency of the treated sound. Here, in order to introduce pass range δ, experiments were performed to study sound source extraction ratio for one sound source, using five pure sounds of the harmonics of 100, 200, 500, 1000, 2000, and 100 Hz and one harmonics. Here, the sound source was moved from 0 degree as the robot front to the position at each 10 degrees within the range of 90 degrees to the robot left or right.

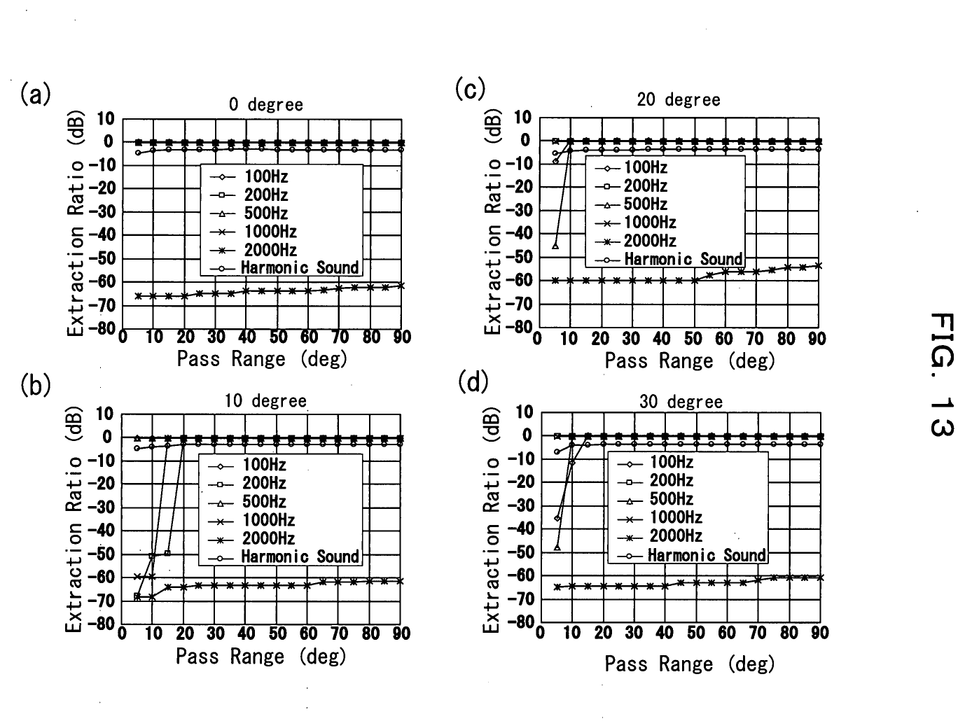

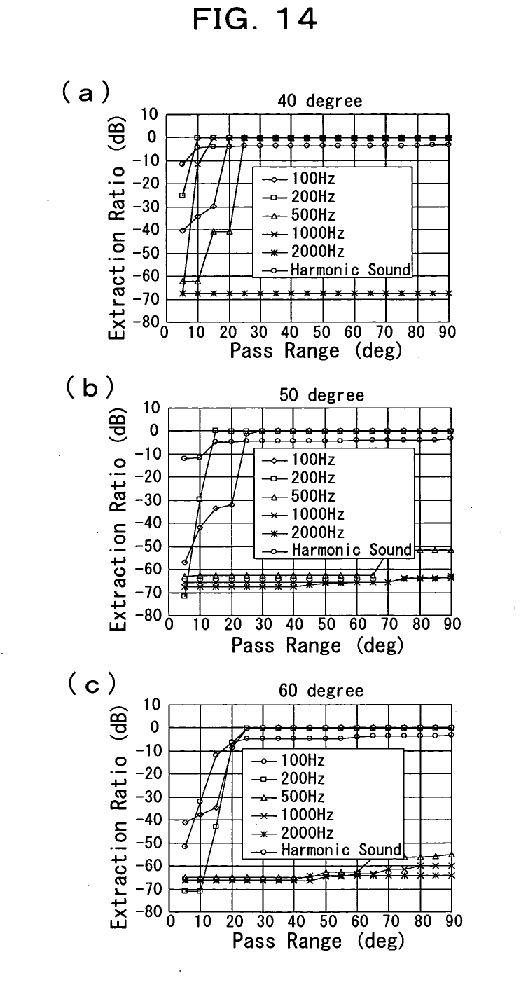

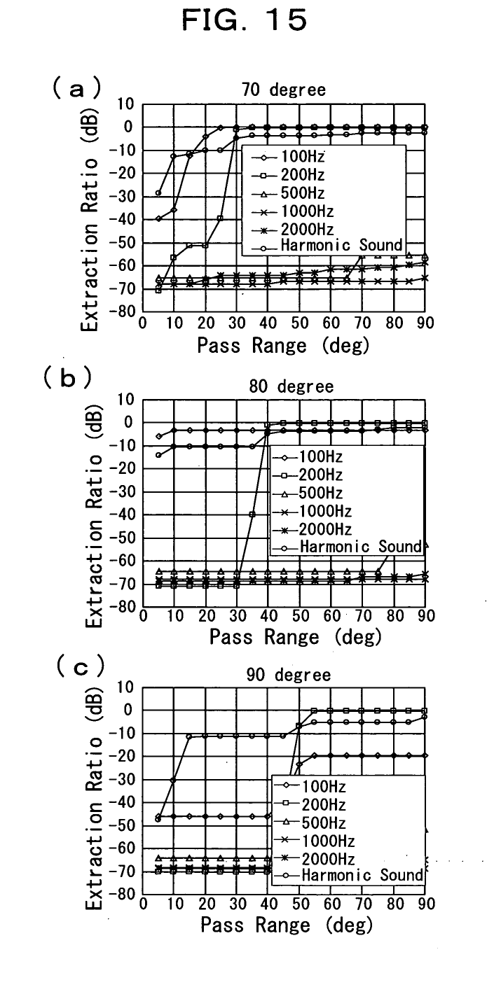

FIGS. 13-15 are graphs showing the sound source extraction ratio in case that the sound source is located at each position within the range from 0 degree to 90 degrees, and, as is shown by these experimental results, the extraction ratio of sound of specific frequency can be improved, and so can be separation accuracy, by controlling pass range width depending upon frequency. Thereby, speech recognition ratio is improved. Therefore, in the above-explained robotics visual and auditory system 17, it is desirable that the pass range of an active direction pass filter 23a is so made as to be controllable for each frequency.

### INDUSTRIAL APPLICABILITY

According to the present invention as described above, accurate speech recognition in real time, real environments is possible by using a plurality of acoustic models, compared with conventional speech recognition. Even more accurate speech recognition, compared with conventional speech recognition, is also possible by integrating the speech recognition results from each acoustic model by a selector, and judging the most reliable speech recognition result.

1. A robotics visual and auditory system comprising;
a plurality of acoustic models,
a speech recognition engine for executing speech recognition processes to separated sound signals from respective sound sources by using the acoustic models, and
a selector for integrating a plurality of speech recognition process results obtained by the speech recognition process, and selecting any one of speech recognition process results,
wherein, in order to respond the case where a plurality of speakers speak to said robot from different directions with the robot's front direction as the base, the acoustic models are provided with respect to each speaker and each direction so to respond each direction,
wherein the speech recognition engine uses each of said acoustic models separately for one sound signal separated by sound source separation, and executes said speech recognition process in parallel.

2. A robotics visual and auditory system as set forth in claim 1, wherein the selector calculates the cost function value, upon integrating the speech recognition process result, based on the recognition result by the speech recognition process and the speaker's direction, and judges the speech recognition process result having the maximum value of the cost function as the most reliable speech recognition result.

3. A robotics visual and auditory system as set forth in claim 1 or claim 2, wherein it is provided with a dialogue part to output the speech recognition process results selected by the selector to outside.

4. A robotics visual and auditory system comprising;
an auditory module which is provided at least with a pair of microphones to collect external sounds, and, based on sound signals from the microphones, determines a direction of at least one speaker by sound source separation and localization by grouping based on pitch extraction and harmonic sounds,
a face module which is provided a camera to take images of a robot's front, identifies each speaker, and extracts his face event from each speaker's face recognition and localization, based on images taken by the camera,
a motor control module which is provided with a drive motor to rotate the robot in the horizontal direction, and extracts motor event, based on a rotational position of the drive motor,
an association module which determines each speaker's direction, based on directional information of sound source localization of the auditory event and face localization of the face event, from said auditory, face, and motor events, generates an auditory stream and a face stream by connecting said events in the temporal direction using a Kalman filter for determinations, and further generates an association stream associating these streams, and
an attention control module which conduct an attention control based on said streams, and drive-controls the motor based on an action planning results accompanying the attention control,
in order for the auditory module to respond the case where a plurality of speakers speak to said robot from different directions with the robot's front direction as the base, acoustic models are provided in each direction so to respond each speaker, and each direction,
wherein the auditory module collects sub-bands having interaural phase difference (IPD) or interaural intensity difference (IID) within a predetermined range by an active direction pass filter having a pass range which, according to auditory characteristics, becomes minimum in the frontal direction, and larger as the angle becomes wider to the left and right, based on an accurate sound source directional information from the association module, and conducts sound source separation by restructuring a wave shape of a sound source, conducts speech recognition in parallel for one sound signal separated by sound source separation using a plurality of the acoustic models, integrates speech recognition results from each acoustic model by a selector, and judges the most reliable speech recognition result among the speech recognition results.

5. A robotics visual and auditory system comprising;
an auditory module which is provided at least with a pair of microphones to collect external sounds, and, based on sound signals from the microphones, determines a direction of at least one speaker by sound source separation and localization by grouping based on pitch extraction and harmonic sounds,
a face module which is provided a camera to take images of a robot's front, identifies each speaker, and extracts his face event from each speaker's face recognition and localization, based on images taken by the camera,
a stereo module which extracts and localizes a longitudinally long matter, based on a parallax extracted from images taken by a stereo camera, and extracts stereo event,
a motor control module which is provided with a drive motor to rotate the robot in the horizontal direction, and extracts motor event, based on a rotational position of the drive motor,
an association module which determines each speaker's direction, based on directional information of sound source localization of the auditory event and face localization of the face event, from said auditory, face, stereo, and motor events, generates an auditory stream, a face stream and a stereo visual stream by connecting said events in the temporal direction using a Kalman filter for determinations, and further generates an association stream associating these streams, and
an attention control module which conduct an attention control based on said streams, and drive-controls the motor based on an action planning results accompanying the attention control,
in order for the auditory module to respond the case where a plurality of speakers speak to said robot from different directions with the robot's front direction as the base, acoustic models are provided in each direction so to respond each speaker, and each direction,
wherein the auditory module collects sub-bands having interaural phase difference (IPD) or interaural intensity difference (IID) within a predetermined range by an active direction pass filter having a pass range which, according to auditory characteristics, becomes minimum in the frontal direction, and larger as the angle becomes wider to the left and right, based on an accurate sound source directional information from the association module, and conducts sound source separation by restructuring a wave shape of a sound source, conducts speech recognition in parallel for one sound signal separated by sound source separation using a plurality of the acoustic models, integrates speech recognition results from each acoustic model by a selector, and judges the most reliable speech recognition result among the speech recognition results.

6. A robotics visual and auditory system as set forth in claim 4 or claim 5, characterized in that;
when the speech recognition by the auditory module failed, the attention control module is made up as to collect speeches again from the microphones with the microphones and the camera turned to the sound source direction of the sound signals, and to perform again speech recognition of the speech by the auditory module, based on the sound signals conducted sound source localization and sound source separation.

7. A robotics visual and auditory system as set forth in claim 4 or claim 5, characterized in that;
the auditory module refers to the face event from the face module upon performing the speech recognition.

8. A robotics visual and auditory system as set forth in claim 5, characterized in that;
the auditory module refers to the stereo event from the stereo module upon performing the speech recognition.

9. A robotics visual and auditory system as set forth in claim 5, characterized in that;
the auditory module refers to the face event from the face module and the stereo event from the stereo module upon performing the speech recognition.

10. A robotics visual and auditory system as set forth in claim 4 or claim 5, wherein it is provided with a dialogue part to output the speech recognition results judged by the auditory module to outside.

11. A robotics visual and auditory system as set forth in claim 4 or claim 5, wherein a pass range of the active direction pass filter can be controlled for each frequency.

12. A robotics visual and auditory system as set forth in claim 4 or claim 5, wherein the selector calculates the cost function value, upon integrating the speech recognition result, based on the recognition result by the speech recognition and the direction determined by the association module, and judges the speech recognition process result having the maximum value of the cost function as the most reliable speech recognition result.

13. A robotics visual and auditory system as set forth in claim 4 or claim 5, characterized in that; it recognizes the speaker's name based on the acoustic model utilized to obtain speech recognition result.
